(19) United States
(12) Patent Application Publication
(10) Pub. No.: US 2025/0117700 A1
(43) Pub. Date: Apr. 10, 2025

(54) INFORMATION PROCESSING SYSTEM

(71) Applicant: Toyota Jidosha Kabushiki Kaisha, Toyota-shi (JP)

(72) Inventors: Yosuke UENO, Nagoya-shi (JP); Kazuya MATSUMOTO, Nagoya-shi (JP); Naritomo MIURA, Toyota-shi (JP)

(73) Assignee: Toyota Jidosha Kabushiki Kaisha, Toyota-shi (JP)

(21) Appl. No.: 18/758,574

(22) Filed: Jun. 28, 2024

(30) Foreign Application Priority Data
Oct. 6, 2023 (JP) 2023-174233

(51) Int. Cl. G06N 20/00

(52) U.S. Cl. CPC G06N 20/00

(57) ABSTRACT

The information processing system includes a generator configured to generate, by generative AI trained using user data including information with which an individual is identifiable, a plurality of pieces of artificial data that is used to train a computational model different from the generative AI and does not include information with which an individual is identifiable.

### CROSS-REFERENCE TO RELATED APPLICATION

This application claims priority to Japanese Patent Application No. 2023-174233 filed on Oct. 6, 2023, incorporated herein by reference in its entirety.

### BACKGROUND

### 1. Technical Field

The present disclosure relates to a technical field of information processing systems.

### 2. Description of Related Art

As a system of this type, for example, there has been proposed a system in which, when concealing personal information, image data to which the personal information is added is copied, the personal information is concealed, and the image data is stored as an imaginary subject (Japanese Unexamined Patent Application Publication No. 2009-118889 (JP 2009-118889 A)).

### SUMMARY

When a request for deletion of personal data is made by an individual in accordance with provisions pertaining to the right to deletion (so-called “forgotten” right), the personal data shall be deleted. Personal data may be used as learning data for a computational model related to artificial intelligence (AI). The learning data is also used, for example, to verify the behavior of the AI. When the personal data serving as the learning data is deleted due to the request for deletion of the personal data, there is a technical problem of difficulty in verifying the behavior of the AI.

The present disclosure has been made in view of the above problem, and an object of the present disclosure is to provide an information processing system capable of achieving both compliance with provisions pertaining to the right to deletion and verification of the behavior of AI.

An information processing system according to an aspect of the present disclosure includes a generator configured to generate, by generative artificial intelligence trained using user data including information with which an individual is identifiable, a plurality of pieces of artificial data that is used to train a computational model different from the generative artificial intelligence and does not include information with which an individual is identifiable.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating a concept of an example of an information processing system according to an embodiment;

FIG. 2 is a flow chart illustrating an operation of the determination device according to the embodiment; and

FIG. 3 is a conceptual diagram illustrating a concept of another example of the information processing system according to the embodiment.

### DETAILED DESCRIPTION OF EMBODIMENTS

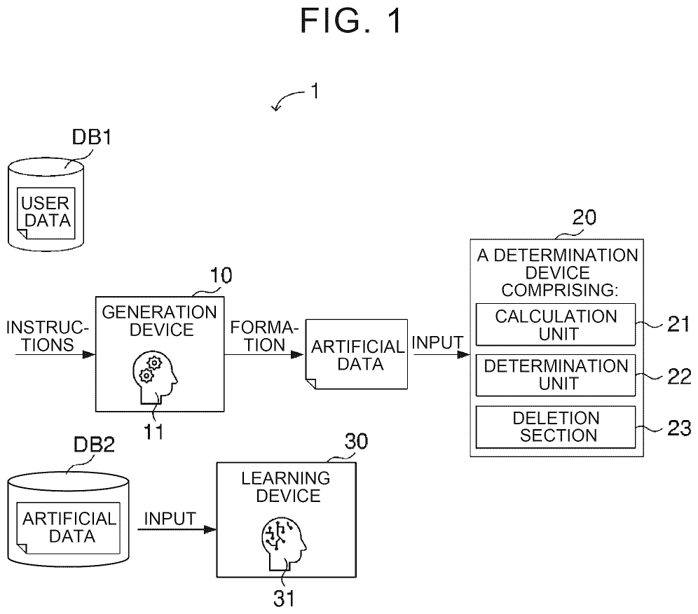

An embodiment of an information processing system will be described with reference to FIG. 1. In FIG. 1, the information processing system 1 includes a generation device 10, a determination device 20, and a learning device 30. The information processing system 1 includes a database DB 1 including user data and a database DB2 including artificial data.

Each of the generation device 10, the determination device 20, the learning device 30, and the extraction device 40 may include, for example, an arithmetic processing unit, a storage unit, and a communication unit as hardware. The arithmetic processor may include, for example, at least one of Central Processing Unit (CPU) and Graphics Processing Unit (GPU). The storage unit may include, for example, at least one of a Random Access Memory (RAM), a Read Only Memory (ROM), a hard disk device, a magneto-optical disk device, a Solid State Drive (SSD), and an optical disk array.

The generation device 10 includes a generative AI 11. The generative AI 11 is a generative AI constructed by performing training using user data (typically a plurality of user data) included in the database DB1. It is to be noted that various aspects of the present disclosure can be applied to methods of constructing a generative AI 11. Therefore, detailed explanation of how to construct the generative AI 11 will be omitted.

The user data included in the database DB1 will be described. The user data may be, for example, image data including a face of the user. That is, the user data may be image data related to an image in which the face of the user is captured. Such user data may be generated, for example, by capturing an image of a person riding on the vehicle by a camera (for example, a driver monitor camera) that captures an image of the inside of the vehicle.

When the user data is image data including the face of the user, the generative AI 11 learned using the user data may be capable of generating new image data including the face. For example, the user data may be image data captured by a driver monitor camera, including a face of a driver of the vehicle. In this case, the generative AI 11 learned using the user data may generate image data of the angle of view and the angle of the neck corresponding to the angle of view and the angle of the neck, respectively, related to the image data generated by the driver monitor camera capturing the driver of the vehicle. Note that the generative AI 11 may be constructed by fine tuning in which a pre-learned model (for example, a base model) is re-learned using user data.

The generation device 10 may receive an instruction from an operator of the generation device 10. The instruction by the operator may be represented by textual information. The generation device 10 may enter an instruction from the operator into the generative AI 11. generative AI 11 instructed by the operator is inputted may generate an artificial datum according to the instruction. That is, the generation device 10 may generate artificial data using the generative AI 11.

For example, when the instruction of the operator is “a face of a woman in her 70's”, the generative AI 11 may generate image data including a face of an imaginary woman in her 70's as the artificial data. For example, when the instruction of the operator is “a face of a man in his/her twenties”, the generative AI 11 may generate image data including a face of an imaginary man in his/her twenties as the artificial data. Note that the generative AI may generate one artificial data or a plurality of artificial data in response to an instruction from one operator.

The user data often includes information that is personally identifiable. For example, since the image data including the face of the user corresponds to the personal information, it can be said that the image data including the face of the user includes the information capable of specifying the individual. It can be said that the image data generated by the generative AI 11 and including the face of an imaginary person is image data that does not include information that can identify an individual. That is, by generating artificial data using the generative AI 11, it is possible to generate a large amount of data that does not include information that can identify individuals.

The determination device 20 determines whether or not the artificial data generated by the generation device 10 (specifically, the generative AI 11) is similar to the user data included in the database DB1. The determination device 20 includes a calculation unit 21, a determination unit 22, and a deletion unit 23. Note that the calculation unit 21, the determination unit 22, and the deletion unit 23 may be implemented as logical functional blocks or may be implemented as physical processing circuits.

The calculation unit 21 calculates a degree of similarity indicating a degree of similarity between one artificial data among the plurality of artificial data generated by the generation device 10 and each of the plurality of user data included in the database DB1. Various existing aspects can be applied to the method of calculating the similarity. An example of a method of calculating the similarity will be described below. For example, it is assumed that the user data is image data including a face of an actual person, and the artificial data is image data including a face of an imaginary person. Further, it is assumed that the user data includes coordinate information indicating coordinates of one or more feature points related to the face. It is assumed that the artificial data also includes coordinate information indicating coordinates of one or more feature points related to the face. The facial feature point may be, for example, at least one of a right eye, a left eye, a nose, and a mouth. For example, the calculation unit 21 may compare the coordinates of the first feature point indicated by the coordinate information included in the user data with the coordinates of the feature point corresponding to the first feature point indicated by the coordinate information included in the artificial data. The calculation unit 21 may increase the similarity as the distance between the coordinates of the first feature point and the coordinates of the feature point corresponding to the first feature point is shorter. For example, the calculation unit 21 may compare the relative relationship between the coordinates of the first feature point indicated by the coordinate information included in the user data and the coordinates of the second feature point, and the relative relationship between the coordinates of the feature point corresponding to the first feature point and the coordinates of the feature point corresponding to the second feature point indicated by the coordinate information included in the artificial data. For example, the calculation unit 21 may increase the similarity as the difference between the distance between the first feature point and the second feature point as the relative relationship and the distance between the feature point corresponding to the first feature point and the feature point corresponding to the second feature point as the relative relationship decreases. The calculation unit 21 may compare the feature amount related to the user data with the feature amount related to the artificial data. For example, the calculation unit 21 may calculate the distance between the feature amount vector corresponding to the feature amount related to the user data and the feature amount vector corresponding to the feature amount related to the artificial data, and increase the similarity as the calculated distance becomes shorter. For example, the calculation unit 21 may calculate the cosine similarity based on the direction of the feature amount vector corresponding to the feature amount related to the user data and the direction of the feature amount vector corresponding to the feature amount related to the artificial data.

The determination unit 22 determines whether or not the degree of similarity calculated by the calculation unit 21 is equal to or greater than a predetermined value. The deletion unit 23 deletes one artificial data whose similarity is determined to be equal to or greater than a predetermined value by the determination unit 22. Here, the “predetermined value” is a value for determining whether or not to delete one artificial data. The predetermined value may be a predetermined fixed value. Note that the predetermined value may be a variable value according to some parameter. The determination device 20 registers, in the database DB2, one artificial data whose similarity is determined by the determination unit 22 to be less than a predetermined value.

For example, it is assumed that the generative AI 11 generates, as artificial data, image data including a face of an imaginary person. In this case, artificial data such that a specific person (that is, an actual person) can be recalled from a face of an imaginary person may be generated. In other words, the generative AI 11 may generate artificial data including information corresponding to information capable of identifying individuals. Therefore, as described above, the determination device 20 deletes one artificial data whose similarity degree is determined to be equal to or greater than a predetermined value, thereby preventing the artificial data including information corresponding to the information capable of specifying the individual from being stored in the database DB2. From this point of view, for example, a range in which a degree of similarity in a case where an individual can be specified can be obtained from artificial data may be obtained, and the predetermined value may be set as a lower limit value of the obtained range.

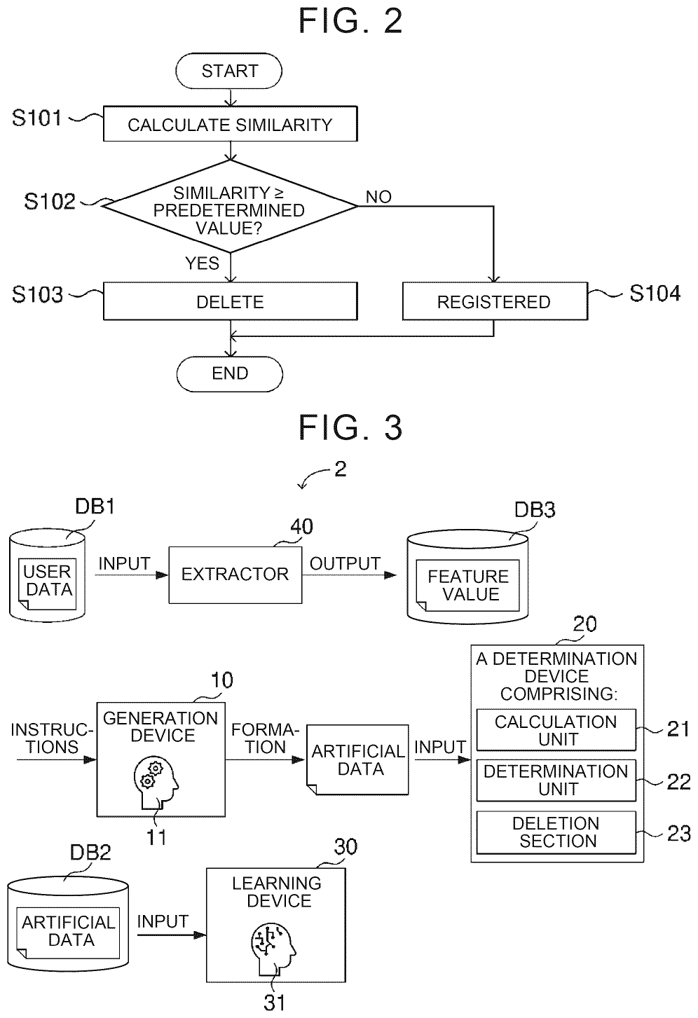

The operation of the determination device 20 will now be described with reference to the flowchart of FIG. 2. In FIG. 2, the calculation unit 21 of the determination device 20 calculates the similarity between one artificial data generated by the generation device 10 and each of the plurality of user data included in the database DB1 (S101). As a result of S101 process, a plurality of similarities may be calculated by the calculation unit 21.

The determination unit 22 determines whether or not the degree of similarity calculated by the calculation unit 21 is equal to or greater than a predetermined value (S102). When at least one of the plurality of similarities calculated by the calculation unit 21 is equal to or greater than the predetermined value, the determination unit 22 may determine that the similarity is equal to or greater than the predetermined value in S102 process. On the other hand, when all of the plurality of similarities calculated by the calculation unit 21 are less than the predetermined value, the determination unit 22 may determine that the similarity is not greater than or equal to the predetermined value (that is, the similarity is less than the predetermined value) in S102 process.

In S102 process, when it is determined that the similarity is equal to or greater than the predetermined value (S102: Yes), the deletion unit 23 deletes the one artificial data (S103). On the other hand, in S102 process, when it is determined that the similarity is not equal to or greater than the predetermined value (S102: No), the determination device 20 registers the one artificial data in the database DB2 (S104). Note that the operation illustrated in FIG. 2 may be performed each time the generation device 10 generates artificial data.

Returning to FIG. 1, the learning device 30 includes a computational model 31. The computational model 31 is a model before machine learning is performed (for example, a model in which weighting is not optimized). The learning device 30 learns the computational model 31 using artificial data (typically, a plurality of artificial data) included in the database DB2. Note that various existing aspects can be applied to the learning method of the computational model 31. Therefore, detailed description of the learning method of the computational model 31 will be omitted.

### Technical Effect

For example, the user data may be collected by an operator who provides a service to the user after obtaining the user's consent. For example, in the case of a business operator that provides a service for detecting at least one of inattentive driving and dozing driving from an image obtained by capturing an inside of a vehicle, image data including a face of a user driving the vehicle may be collected after obtaining the consent of the user.

For example, the learning device 30 may learn the computational model 31 to construct a learned model for detecting at least one of inattentive driving and dozing driving. The learned model is constructed by learning the computational model 31 using the user data. After that, if the user data is deleted due to the user's request to delete the user data, it may be difficult to verify the behavior of the learned model.

On the other hand, in the information processing system 1, the artificial data generated by the generation device 10 (specifically, the generative AI 11) is used to learn the computational model 31. Therefore, even if the user data is deleted by the deletion request, the artificial data included in the database DB2 is not affected. Therefore, the information processing system 1 can achieve both compliance with the provisions relating to the right of deletion and verification of the behavior of the learned model (in other words, AI).

Note that the generation device 10, the determination device 20, and the learning device 30 are not limited to separate devices. For example, the generation device 10, the determination device 20, and the learning device 30 may be implemented by a single device having a plurality of functions respectively corresponding to at least two of the generation device 10, the determination device 20, and the learning device 30. The user data is not limited to the image data including the face of the user described above. The user data may be, for example, voice data. As described above, in the information processing system 1, the learning device 30 learns the computational model 31. Therefore, the information processing system 1 may be referred to as a learning system.

### Modified Examples

A modification of the embodiment of the information processing system will be described with reference to FIG. 3. In FIG. 3, the information processing system 2 includes a generation device 10, a determination device 20, a learning device 30, and an extraction device 40. The information processing system 3 includes a database DB1 including user data, a database DB2 including artificial data, and a database DB3 including characteristic quantities.

The extraction device 40 extracts a characteristic quantity of the user data included in the database DB1. The extraction device 40 may extract features of all of the plurality of user data included in the database DB1. Note that various existing aspects can be applied to a method of extracting a feature amount from user data. Therefore, a detailed description of the extraction method of the feature amount will be omitted. The extraction device 40 registers the feature quantity extracted from the user data in the database DB3. Here, the user data cannot be restored from the feature amount extracted from the user data. Also, it is not possible to recall user data from the feature amount. Therefore, it can be said that the feature amount is data that does not include information capable of specifying an individual.

The calculation unit 21 of the determination device 20 may calculate the similarity using one artificial data among the plurality of artificial data generated by the generation device 10 and a plurality of feature amounts included in the database DB3. For example, the calculation unit 21 may extract a feature amount of one piece of artificial data. The calculation unit 21 may calculate the similarity by comparing the feature amount extracted from one artificial data with each of the plurality of feature amounts included in the database DB3.

### Technical Effect

Due to a user's request to delete user data, the generation device 10 may generate artificial data that closely resembles one user data after one user data included in the database DB1 is deleted. When the calculation unit 21 of the determination device 20 calculates the similarity between one artificial data and the user data included in the database DB1, the similarity between one artificial data and one user data deleted from the database DB 1 is not calculated. Then, there is a possibility that artificial data which closely resembles the one user data is registered in the database DB3.

On the other hand, in the information processing system 2, the calculation unit 21 may calculate the similarity using one artificial data among the plurality of artificial data generated by the generation device 10 and a plurality of feature amounts included in the database DB3. As described above, since the feature amount is data that does not include information capable of specifying an individual, even when the deletion request is made, one feature amount corresponding to one user data for which the deletion request is made is not deleted. Therefore, according to the information processing system 2, even when one piece of user data included in the database DB1 is deleted due to the user's request to delete the user data, it is possible to suppress the artificial data that closely resembles the deleted one piece of user data from being registered in the database DB3.

Various aspects of the disclosure derived from the embodiments and modifications described above are described below.

According to an aspect of the present disclosure, there is provided an information processing system including a generator configured to generate, by generative AI trained using user data including information with which an individual is identifiable, a plurality of pieces of artificial data that is used to train a computational model different from the generative AI and does not include information with which an individual is identifiable. In the above-described embodiment, the generation device 10 corresponds to an example of a generator.

The information processing system may include a calculator that calculates a degree of similarity indicating a degree of similarity between one artificial data among the plurality of artificial data and the user data, a determiner that determines whether the similarity is equal to or greater than a predetermined value, and a deleter that deletes the one artificial data when the similarity is determined to be equal to or greater than the predetermined value. In the above-described embodiment, the calculation unit 21 corresponds to an example of a calculator, the determination unit 22 corresponds to an example of a determiner, and the deletion unit 23 corresponds to an example of a deleter.

Here, each of the user data and the plurality of artificial data may be image data including a face, and each of the user data and the plurality of artificial data may include coordinate information indicating coordinates of one or more feature points related to the face. The calculator may calculate the similarity based on the coordinate information included in the user data and the coordinate information included in the one artificial data.

The information system may include: a database including artificial data in which a degree of similarity indicating a degree of similarity with the user data among the plurality of artificial data is less than the predetermined value; and a trainer configured to learn the computational model using the artificial data included in the database. In the above- described embodiment, the database DB2 corresponds to an example of a database, and the learning device 30 corresponds to an example of a trainer.

The information system may include an extractor that extracts a feature amount of the user data from the user data, and a storage unit that stores the feature amount, and the calculator may calculate the similarity using the feature amount and the one artificial data. In the above-described embodiment, the extraction device 40 corresponds to an example of an extractor, and the database DB3 corresponds to an example of a storage unit.

The present disclosure is not limited to the above-described embodiments, and can be modified as appropriate within the scope and spirit of the disclosure that can be read from the claims and the entire specification. An information processing system with such a change is also included in the technical scope of the present disclosure.

What is claimed is:

1. An information processing system comprising a generator configured to generate, by generative artificial intelligence trained using user data including information with which an individual is identifiable, a plurality of pieces of artificial data that is used to train a computational model different from the generative artificial intelligence and does not include information with which an individual is identifiable.

2. The information processing system according to claim 1, further comprising:
a calculator configured to calculate a similarity degree indicating a degree of similarity between one piece of artificial data out of the plurality of pieces of artificial data and the user data;
a determiner configured to determine whether the similarity degree is equal to or higher than a predetermined value; and
a deleter configured to delete the one piece of artificial data when determination is made that the similarity degree is equal to or higher than the predetermined value.

3. The information processing system according to claim 2, wherein:
each of the user data and the plurality of pieces of artificial data is image data including a face;
each of the user data and the plurality of pieces of artificial data includes coordinate information indicating coordinates of one or more feature points related to the face; and
the calculator is configured to calculate the similarity degree based on the coordinate information included in the user data and the coordinate information included in the one piece of artificial data.

4. The information processing system according to claim 2, further comprising:
a database including artificial data in which the similarity degree indicating the degree of similarity to the user data is lower than the predetermined value out of the plurality of pieces of artificial data; and
a trainer configured to train the computational model using the artificial data included in the database.

5. The information processing system according to claim 2, further comprising:
an extractor configured to extract a feature amount of the user data from the user data; and
a storage configured to store the feature amount, wherein the calculator is configured to calculate the similarity degree using the feature amount and the one piece of artificial data.
